(19) United States
(12) Patent Application Publication
(10) Pub. No.: US 2014/0006388 A1
(43) Pub. Date: Jan. 2, 2014

(54) EVENT SEARCHING AND SUGGESTION

(71) Applicants: Zachary Yeskel, San Francisco, CA (US); Anton Lopyrev, San Francisco, CA (US); Tianxuan Chen, San Francisco, CA (US); Kavi Harshawat, San Francisco, CA (US); Matthew Steiner, Mountain View, CA (US); Denise Ho, Los Altos, CA (US); Dave Cohen, Mountain View, CA (US); Ajmal Asver, San Francisco, CA (US); James Gallagher, Sunnyvale, CA (US)

(72) Inventors: Zachary Yeskel, San Francisco, CA (US); Anton Lopyrev, San Francisco, CA (US); Tianxuan Chen, San Francisco, CA (US); Kavi Harshawat, San Francisco, CA (US); Matthew Steiner, Mountain View, CA (US); Denise Ho, Los Altos, CA (US); Dave Cohen, Mountain View, CA (US); Ajmal Asver, San Francisco, CA (US); James Gallagher, Sunnyvale, CA (US)

(73) Assignee: Google Inc., Mountain View, CA (US)

(21) Appl. No.: 13/534,847

(22) Filed: Jun. 27, 2012

(51) Int. Cl. G06F 17/30

(52) U.S. Cl. 707/723; 707/E17.014

(57) ABSTRACT

A method and system for event searching and suggestion is described. A method may include determining one or more result events to recommend to attend based upon, at least in part, at least one of: an indication of a location of a client computing device associated with a user, and an index associated with the event, the index based upon, at least in part, event content associated with the event. The method may also include ranking the one or more result events based upon, at least in part, at least one of: the index associated with the event and the indication of the location. The method may further include providing the ranked one or more result events

### TECHNICAL FIELD

This disclosure relates to event management and, more particularly, to an event process.

### BACKGROUND

A user may use an event application to manage events. The event application may allow the user to invite others to an event. The event application may also allow the user to receive an invitation to another event. The user may have attended events in the past and may be interested in attending future events. Further, connections (e.g., friends) of the user on a social network may have attended events in the past and may attend events in the future.

### SUMMARY OF DISCLOSURE

In an embodiment, a method may include, in an event management application associated with a social networking application, receiving, at a computing device, a search request for an event to attend. The method may also include, in response to receiving the search request, determining, at the computing device, one or more result events of one or more events to recommend to a user based upon, at least in part, one or more of information associated with the search, information associated with the user, information associated with the one or more events, and a location of a client computing device associated with a user. The location of the client computing device may be based upon, at least in part, a received indication of the location of the client computing device. The method may also include ranking, at the computing device, the one or more result events based upon, at least in part, one or more of the information associated with the search, the information associated with the user, the information associated with the one or more events, and the location. The information associated with the user may be based upon, at least in part, at least one of: a user interest, an online activity associated with the user, and media content associated with the user. The information associated with the one or more events may be based upon, at least in part, at least one of: an event that the user previously attended, and an event associated with a connection of the user. The method may further include providing, from, at least in part, the computing device, the ranked one or more result events.

In another embodiment, a method may include determining one or more result events to recommend to attend based upon, at least in part, at least one of: an indication of a location of a client computing device associated with a user, and an index associated with the event. The index may be based upon, at least in part, event content associated with the event. The method may also include ranking the one or more result events based upon, at least in part, at least one of: the index associated with the event and the indication of the location. The method may further include providing, from a computing device, the ranked one or more result events.

One or more of the following features may be included. Updating the index associated with the event may be based upon, at least in part, receiving an indication that event content associated with the event has changed. Determining the one or more result events may be further based upon, at least in part, a user characteristic. The one or more result events may be provided in response, at least in part, to receiving a search request. The one or more result events may be provided as one or more suggestions without receiving a search request. The event content may include, at least in part, at least one of: event information including an invitee, an attendee, an event category, an event host, and an event organization. Determining the one or more result events may be further based upon, at least in part, at least one of: an event that a user previously attended, and an event associated with a connection of a user.

The method may also include determining the location of the client computing device based upon, at least in part, the received indication of the location of the client computing device. Determining the location of the client computing device may b e based upon, at least in part, one or more of an IP address associated with the client computing device, location-based information associated with the client computing device, and a location received via a search request.

The one or more result events may be ranked based upon, at least in part a nearness to the location of the client computing device. Updating the location of the client computing device may be based upon, at least in part, another received indication of the location of the client computing device. Updating the ranking of the one or more result events may be based upon, at least in part, the other received indication of the location of the client computing device.

In another embodiment, a computing system may include one or more processors. The one or more processors may be configured to determine one or more result events of one or more events to recommend to attend based upon, at least in part, one or more of information associated with a user and information associated with the one or more events. The one or more processors may also be configured to determine a score for the one or more result events based upon, at least in part, one or more of the information associated with the user and the information associated with the one or more events. The one or more processors may also be configured to determine a rank of the one or more result events based upon, at least in part, the score determined for the one or more result events. The one or more processors may further be configured to provide, from, at least in part, a computing device, the ranked one or more result events.

One or more of the following features may be included. The one or more processors may be further configured to create an index associated with an event based upon, at least in part, information associated with the event. The one or more processors may also be configured to update the index associated with the event based upon, at least in part, receiving an indication that the information associated with event has changed. The one or more result events may be provided in response, at least in part, to receiving a search request. The one or more result events may be provided as one or more suggestions without receiving a search request.

The information associated with the one or more events may include, at least in part, at least one of: event content, event information including an invitee, an attendee, an event category, an event host, and an event organization. The information associated with the user may be based upon, at least in part, at least one of: a user characteristic, a user interest, an online activity associated with the user, media content associated with the user, and a location of a client computing device associated with the user. The one or more processors may be further configured to determine the location of the client computing device associated with the user based upon, at least in part, a received indication of the location of the client computing device.

Determining the location of the client computing device may be based upon, at least in part, one or more of an IP address associated with the client computing device, a location-based information associated with the client computing device, and a location received via a search request. The one or more result events may be scored based upon, at least in part, a nearness to the location of the client computing device. The one or more processors may be further configured to update the location of the client computing device based upon, at least in part, another received indication of the location of the client computing device. The one or more processors may also be configured to update the scoring of the one or more result events based upon, at least in part, the other received indication of the location of the client computing device.

Determining the one or more result events may be further based upon, at least in part, at least one of: an event that the user previously attended, and an event associated with a connection of the user. The event associated with the connection of the user may be based upon, at least in part, at least one of: an event that a connection of the user previously attended, an event for which a connection of the user indicated an intent to attend, an event hosted by a connection of the user, and an event associated with an organization that the user is connected to. The one or more processors may be further configured to determine at least one of: the event that the user previously attended, and the event associated with the connection of the user based upon, at least in part, an index associated with an event.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an event process, according to an embodiment of the present disclosure;

FIG. 2 is a flowchart of the event process of FIG. 1, according to an embodiment of the present disclosure;

FIG. 3 is a diagrammatic flow chart of the event process of FIG. 1, according to an embodiment of the present disclosure;

FIG. 4 is a graphical user interface associated with the event process of FIG. 1, according to an embodiment of the present disclosure; and

FIG. 5 is a diagrammatic view of the computing device of FIG. 1.

Like reference symbols in the various drawings indicate like elements.

### DETAILED DESCRIPTION OF EXAMPLE EMBODIMENTS

One or more techniques or features described in the present disclosure may be used to facilitate searching for and/or suggesting events for a user to attend. In an embodiment, event process 10 may be associated with or may operate in connection with an event management application that may allow users to manage events and/or search for events. Further, event process 10 may suggest events to the users. The event management application may allow users to create, via, at least in part, event process 10, one or more events. The event management application may further allow users to invite other users to events, receive invitations to events, and post content related to events.

Further, in an embodiment, event process 10 or the event management application may be associated with a social networking application or may operate in connection with the social networking application. The social networking application may allow the users to become friends or online connections and may allow the users to share messages and content. Event process 10 may facilitate, via the event management application and/or the social networking application, the users in inviting their friends or online connections to events and in receiving invitations to events from their friends or online connections.

It should be noted that in an embodiment, event process 10 may operate without being associated with the event management application and/or the social networking application.

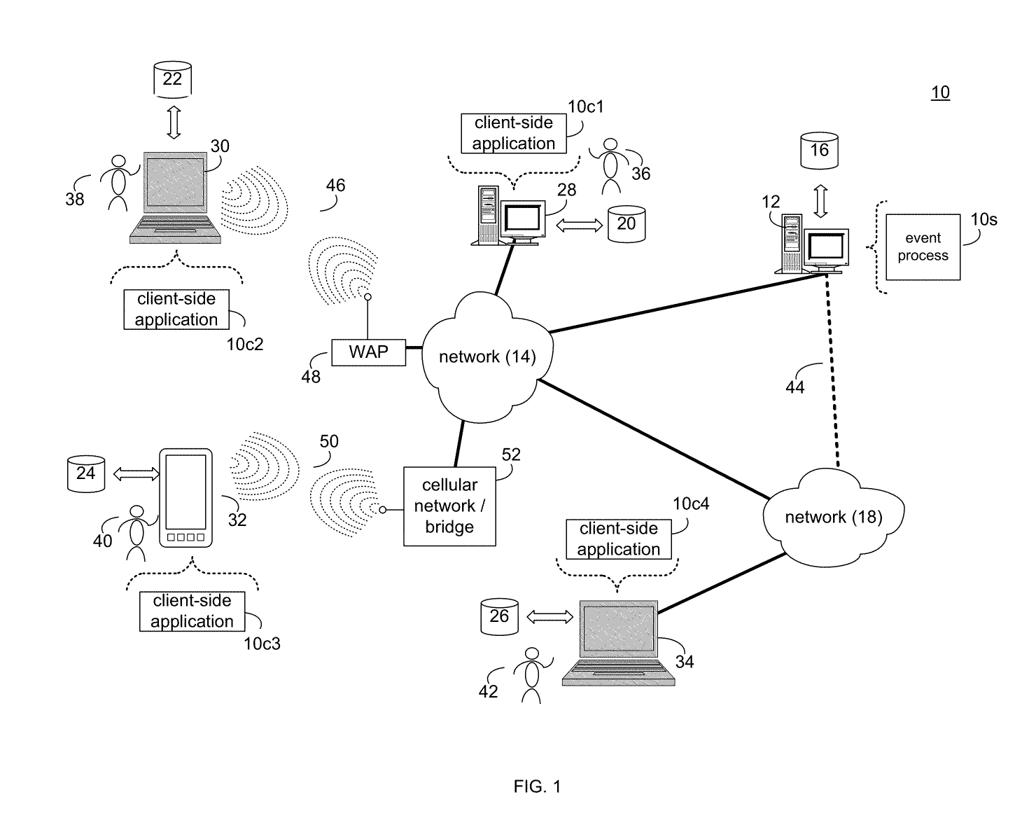

Referring to FIG. 1, there is shown event process 10. For the following discussion, it is intended to be understood that event process 10 may be implemented in a variety of ways. For example, event process 10 may be implemented as a server-side process, a client-side process, or a server-side/client-side process.

For example, event process 10 may be implemented as a purely server-side process via event process 10s. Alternatively, event process 10 may be implemented as a purely client-side process via one or more of client-side application 10c1, client-side application 10c2, client-side application 10c3, and client-side application 10c4. Alternatively still, event process 10 may be implemented as a server-side/client-side process via event process 10s in combination with one or more of client-side application 10c1, client-side application 10c2, client-side application 10c3, and client-side application 10c4.

Accordingly, event process 10 as used in this disclosure may include any combination of event process 10s, client-side application 10c1, client-side application 10c2, client-side application 10c3, and client-side application 10c4.

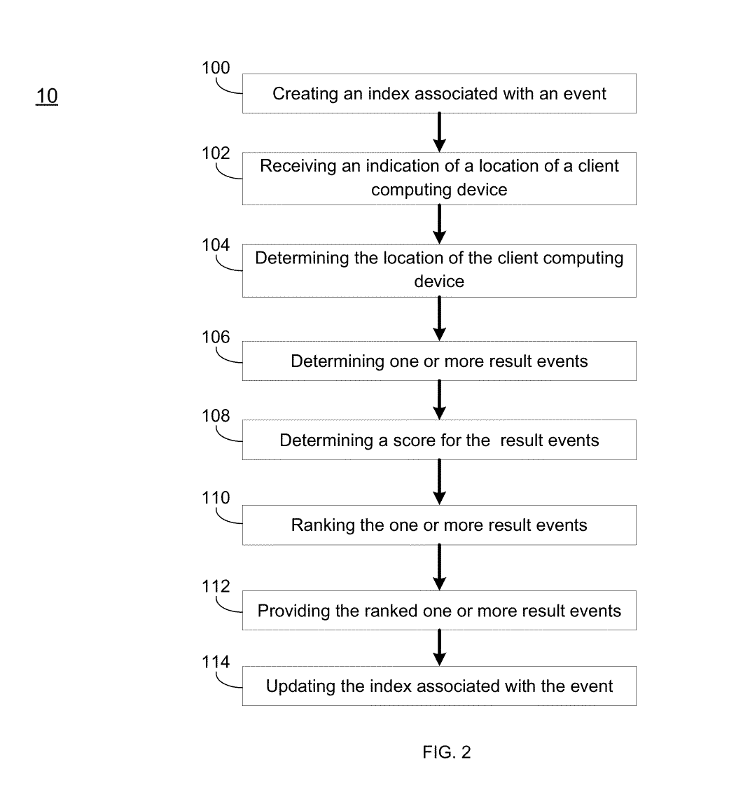

Referring also to FIG. 2 and as will be discussed below in greater detail, event process 10 may create 100 an index associated with an event based upon, at least in part, event content associated with the event. Event process 10 may further determine 106 one or more result events of the one or more events to recommend to attend based upon, at least in part, the index associated with the event. Event process 10 may also determine 108 a score for the one or more result events based upon, at least in part, the information associated with the user and the information associated with the one or more events. Further, event process 10 may rank 110 the one or more result events based upon, at least in part, the index associated with the event. Moreover, event process 10 may provide 112 the ranked one or more result events. Additionally, event process 10 may update 114 the index associated with the event based upon, at least in part, receiving an indication that event content associated with the event has changed.

Event process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of event process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to a web browser, a game console user interface, a television user interface, or a specialized application (e.g., an application running on a mobile platform). The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a data-enabled television console (not shown), and a dedicated network device (not shown). Client electronic devices 28, 30, 32, 34 may each execute an operating system.

Users 36, 38, 40, 42 may access event process 10 directly through network 14 or through secondary network 18. Further, event process 10 may be accessed through secondary network 18 via link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. Additionally, personal computer 34 is shown directly coupled to network 18 via a hardwired network connection.

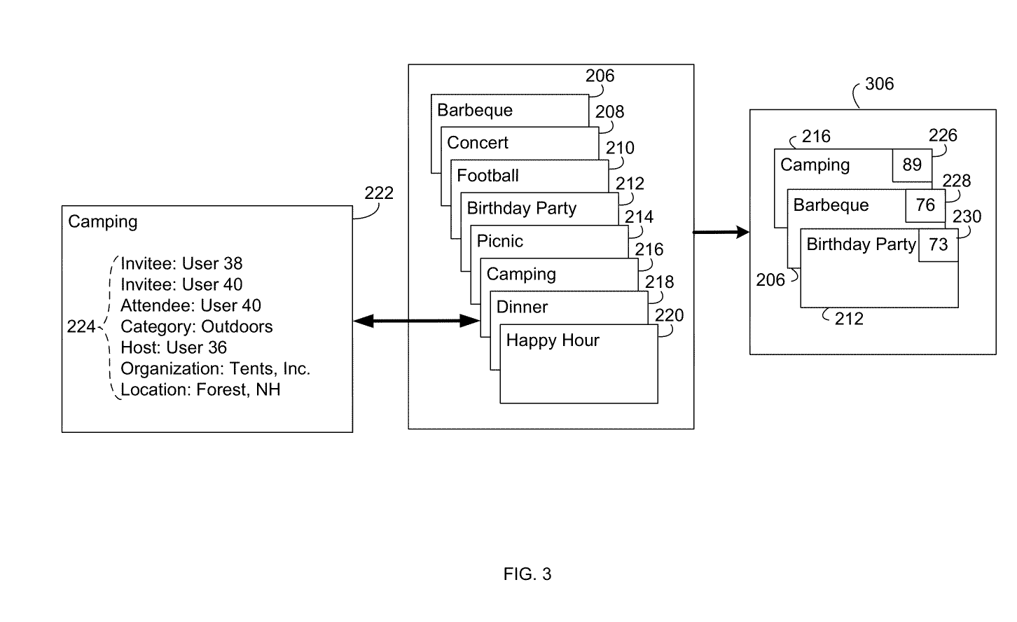

Referring also to FIG. 3 event process 10 may create 100 an index (e.g., index 222). Index 222 may be associated with an event (e.g., event 216 or “Camping”) and may be based upon, at least in part, event content (e.g., event content 224). Event content 224 may be associated with the event (e.g., event 216 or “Camping”). While event 216, index 222, and event content 224 will be discussed herein for example purposes only, event process 10 may create a plurality of indexes for a plurality of events (e.g., events 206, 208, 210, 212, 214, 216, 218, and 220).

As shown in FIG. 3, event content 224 of index 222 associated with event 216 (e.g., “Camping’) may be event information and may include, for example, an invitee of the event (e.g., user 38 and/or user 40), and an attendee of the event (e.g., user 40). Event content 224 may further include a category of the event (e.g., “Outdoors”), a host of the event (e.g., user 36), an organization associated with the event (e.g., “Tents, Inc.”), and a location of the event (e.g., Forrest, N.H.). An attendee of the event may be a user that indicated he/she will attend the event or that has attended a past event.

In an embodiment, index 222 or an index associated with, e.g., events 206, 208, 210, 212, 214, 216, 218, and/or 220 may be stored in a database accessible to event process 10. Event process 10 may access, e.g., index 222 via the database and may add event content to index 222 or may retrieve event content from index 222 via the database.

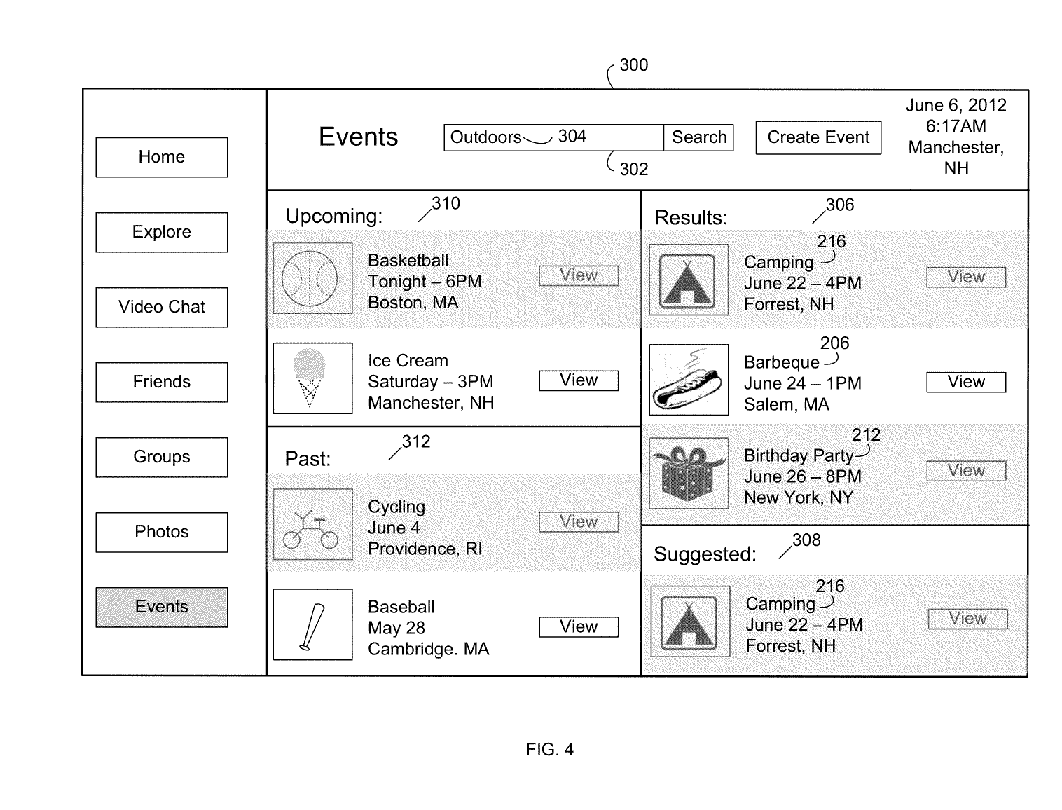

Referring now also to FIG. 4, graphical user interface (GUI) 300 may be associated with event process 10 and/or the event management application and/or the social networking application. GUI 300 may allow a user to create events, view events, search for events, and/or receive suggested events to attend (e.g., suggested by event process 10). GUI 300 may allow the user to view upcoming events that the user has been invited to (e.g., upcoming events 310) and past events that the user has attended (e.g., past events 312).

In an example, a user may enter a search query (e.g., search query 304) in a search field (e.g., search field 302). Event process 10 may receive search query 304 and may process search query 304 to provide one or more search results. The search results (e.g., result events 306) may be viewed by the user via GUI 300.

In an embodiment, event process 10 may receive 102 an indication of a location of a client computing device (e.g. one or more of client electronic devices 28, 30, 32, and/or 34) associated with a user (e.g., one or more of users 36, 38, 40, and/or 42). The indication may be, for example, an IP address associated with the client computing device, location-based information associated with the client computing device, or a text description (e.g., search query) associated with the location of the client computing device.

Further, event process 10 may determine 104 a location of the client computing device (e.g. one or more of client electronic devices 28, 30, 32, and/or 34) associated with a user (e.g., one or more of users 36, 38, 40, and/or 42) based upon, at least in part, the received indication of the location of the client computing device. For example, event process 10 may use a received IP address, location-based information, or a text description associated with the location of the client computing device to determine the location of the client computing device.

Event process 10 may determine 106 one or more result events (e.g., result events 306) of the one or more events (e.g., events 206, 208, 210, 212, 214, 216, 218, and/or 220) to recommend to attend. The one or more determined result events (e.g., result events 306) may be based upon, at least in part, the index (e.g., index 222) associated with the event (e.g., event 216). For example event process 10 may receive query 304 (e.g., “Outdoors”) via, e.g., GUI 300, and may search or parse index 222 or an index associated with, e.g., events 206, 208, 210, 212, 214, 216, 218, and/or 220 for content related to “Outdoors”. Event process 10 may determine that index 222 of event 216 includes content related to “Outdoors” and may determine that event 216 is a result event. Further, event process 10 may determine that an index associated with event 206 (e.g., “Barbeque”) includes content related to “Outdoors” and may determine that event 206 is a result event. Additionally, event process 10 may determine that an index associated with event 212 (e.g., “Birthday Party”) includes content related to “Outdoors” and may determine that event 212 is a result event.

Furthermore, in an embodiment, event process 10 may determine 108 a score (e.g., scores 226, 228, and/or 230) for the one or more result events (e.g., result events 306 or e.g., result events 216, 206, and/or 212). The score (e.g., scores 226, 228, and/or 230) may be based upon, at least in part, information associated with the user and the information associated with the one or more events. For example, event process 10 may determine that the user is a friend or online connection of user 38 and/or user 40, both of whom may be invitees or attendees of event 216. This information (e.g., a user characteristic) associated with the user may be used, at least in part, by event process 10 to determine a score for the result event.

In an embodiment, the score (e.g., scores 226, 228, and/or 230) may be based upon, at least in part, the location of the client computing device (e.g. one or more of client electronic devices 28, 30, 32, and/or 34 associated with one or more of users 36, 38, 40, and/or 42). Further, the score may be based upon, at least in part, a nearness to the location of the client computing device.

For example, and referring also to FIG. 4, assume for illustrative purposes that event process 10 determines that the client computing device associated with the user is located in Manchester, N.H. Further, assume for illustrative purposes that event process 10 determines (via, e.g., one or more event indexes) that event 216 (e.g., “Camping”) is scheduled take place in Forrest, N.H., that event 206 (e.g., “Barbeque”) is scheduled to take place in Salem, Mass., and that event 212 (e.g., “Birthday Party”) is scheduled to take place in New York, N.Y. Event process 10 may determine score 226 for event 216 as the highest score (e.g., “89”), since Forrest, N.H. may be the nearest location to the client computing device (e.g., located in Manchester, N.H.) associated with the user, of the result events (e.g., events 216, 206, and 212). Further, event process 10 may determine score 228 for event 206 as the second highest score (e.g., “76”), since Salem, Mass. may be the second nearest location to the client computing device (e.g., located in Manchester, N.H.) associated with the user, of the result events (e.g., events 216, 206, and 212). Additionally, event process 10 may determine score 230 for event 212 as the third highest score (e.g., “73”), since New York, N.Y. may be the third nearest location to the client computing device (e.g., located in Manchester, N.H.) associated with the user, of the result events (e.g., events 216, 206, and 212).

Event process 10 may also determine that the category “Outdoors” of event 216 matches search query 304. This information associated with event 216 may be used, at least in part, by event process 10 to determine a score for the result event. Event process 10 may further determine that the host (e.g., user 36) of event 216 is a friend or online connection of the user. This information associated with the user may be used, at least in part, by event process 10 to determine a score for the result event. Moreover, event process 10 may determine that the organization (e.g., “Tents, Inc.”) associated with or sponsoring event 216 may be followed by the user online or may otherwise be a friend or online connection of the user. This information associated with event 216 may be used, at least in part, by event process 10 to determine a score for the result event.

In an embodiment, the information associated with the user or the user characteristic may be based upon, at least in part, a user interest, an online activity associated with the user, and media content associated with the user. For example, event process 10 may determine (via, e.g., a social networking application) that a user is interested in barbequing. Event process 10 may use this user characteristic to determine one or more result events such as event 206 (e.g., “Barbeque”). Further, event process 10 may determine (via, e.g., a social networking application) that a user plays fantasy football in an online fantasy football league (e.g., an online activity). Event process 10 may use this user characteristic to determine one or more result events such as event 210 (e.g., “Football”). Additionally, event process 10 may determine (via, e.g., a social networking application) that a user listens to digital recordings of live concerts (e.g., media content). Event process 10 may use this user characteristic to determine one or more result events such as event 208 (e.g., “Concert”).

In an embodiment, information associated with the one or more events may be based upon, at least in part, an event that a user previously attended (or, e.g., a similar previously attended event), or an event associated with a connection of a user. An event associated with a connection of a user may be, for example, an event that a connection of the user previously attended, an event for which a connection of the user indicated an intent to attend, an event hosted by a connection of the user, and/or an event associated with an organization that the user is connected to.

For example, event process 10 may determine that a user has previously attended camping trips. Event process 10 may use this event information to determine one or more result events such as event 216 (e.g., “Camping”). Event process 10 may further determine that multiple connections of the user are having a dinner event. Event process 10 may use this event information to determine one or more result events such as event 218 (e.g., “Dinner”). Event process 10 may determine the event that the user previously attended and/or the event associated with a connection of the user based upon, at least in part, the index (e.g., index 222) associated with the event (e.g., event 216).

In an embodiment, based upon, at least in part, the information associated with the user and the information associated with the one or more events, event process 10 may determine that score 226 for event 216 is “89”, that score 228 for event 206 is “76”, and that score 230 for event 212 is “73”. In an embodiment, scores 226, 228, and/or 230 may be calculated by event process 10 using one or more equations and/or weights. In this way, event process 10 may provide a user-centric set of result events based upon information specific to each user. Further, in this way, event process 10 may determine one or more result events based upon, at least in part, a location of a client computing device associated with a user, a scheduled location of an event, events that relate to the user's interests, events that are similar to events that the user attended previously, events that friends/connections of the user are attending or have attended before, events hosted by friends/connections, events created by organizations associated with web pages or brands that the user follows, events that users with similar interests are attending, and events that relate to the user's online activities, (e.g., videos watched by the user or emails the user received).

Event process 10 may also rank 110 (or, e.g., determine a rank for) the one or more result events (e.g., result events 306). The rank may be based upon, at least in part, the index (e.g., index 222) associated with the event (e.g., event 216). The ranked one or more result events (e.g., result events 216, 206, and 212) may be based upon, at least in part, the indication (e.g., IP address or location-based information) of the location of the client computing device. Further, the ranked one or more result events (e.g., result events 216, 206, and 212) may be based upon, at least in part, a nearness to the location of the client computing device. The ranked one or more result events (e.g., result events 216, 206, and 212) may also be ranked based upon, at least in part, the score (e.g., scores 226, 228, and 230) for each event (e.g., result events 216, 206, and 212).

For example, since event 216 was scored highest (e.g., “89”), event 216 may be the highest ranked event. Since event 206 was scored second highest (e.g., 76), event 206 may be ranked second highest. Since event 212 was scored third highest (e.g., 73), event 212 may be ranked third highest. In this way, event process 10 may use signals (e.g., user information or characteristics or event information) from an event index to inform the determination of result events.

In an embodiment, event process 10 may score each or some of the events (e.g., events 206, 208, 210, 212, 214, 216, 218, and/or 220). The score for each event, which may be based upon a location of the a client computing device associated with a user, information associated with the user, and the information associated with the one or more events, may be used to determine the one or more result events initially, and may also be used to rank the one or more result events. Further, in an embodiment, event process 10 may rank the result events without determining a score for each event. For example, event process 10 may rank the result events based upon one or more assigned weights, user inputs, or other criteria.

Event process 10 may additionally provide 112 the ranked one or more result events (e.g., result events 216, 206, and 212). For example, event process 10 may provide the ranked one or more result events (e.g., result events 216, 206, and 212) such that they are available and or viewable to the user via GUI 300. The ranked one or more result events (e.g., result events 216, 206, and 212) may be provided in order of the highest ranked (e.g., shown first) to the lowest ranked (e.g., shown last). For example, in an embodiment where ranking the result events is based on scoring the result events, the result event with the highest score may appear first, and the result event with the lowest score may appear last.

While the one or more result events may be determined and/or provided in response to receiving a search request from, e.g., a client computing device associated with a user, event process 10 may also determine and/or provide the one or more result events as suggestions. The one or more result events determined and/or provided as suggestions may be determined and/or provided without receiving a search request. In an embodiment, event process 10 may use one or more of the techniques and features described herein to periodically determine the one or more result events as suggestions for the user.

For example, event process 10 may determine, score, rank, and/or provide suggested result events 308. Event process 10 may determine a user-centric score for each or many of the one or more events (e.g., events 206, 208, 210, 212, 214, 216, 218, and/or 220) and may provide the event or events with the highest scores to the user as suggested result events. For example, as event 216 received the highest score (e.g., user-centric score) of the result events for the user, event process 10 may provide event 216 as a suggested result event. While event 216 is the only suggested result event 308 shown in FIG. 4, this is not intended to be a limitation of the present disclosure, as multiple suggested result events may be determined, scored, ranked, and/or provided to the user via GUI 300 using one or more of the techniques and features described herein.

While the result events (e.g., searched for or suggested) may be provided via GUI 300, this is not intended to be a limitation of the present disclosure. For example, the result events may be provided to a user by mail, text message, or push notification.

In an embodiment, event process 10 may update 114 the index (e.g., index 222) associated with the event (e.g., event 216) based upon, at least in part, receiving an indication that event content (e.g., event content 224) associated with the event (e.g., event 216) has changed. For example, as one or more users may indicate an intention to attend or not to attend an event, or as other event content is edited or changed via, e.g., GUI 300, event content 224 may change. Changes to event content 224 may be updated in index 222.

Further, changes to event content 224 updated in index 222 may be used by event process 10 to determine, score, rank, and/or provide result events and event process 10 may update result events for a user based on such changes. For example, if user 40 indicates that he/she will no longer attend the event, or if a sponsoring organization (e.g., “Tents, Inc.”) indicates that they will no longer sponsor the event, this may impact the user-centric result event set provided to the user and/or may change the score or rank of the event.

In an embodiment, event process 10 may receive a feed associated with the one or more events (e.g., events 206, 208, 210, 212, 214, 216, 218, and/or 220). The feed may indicate when event content (e.g., event content 224) has changed and/or when an index (e.g., index 222) has been updated. In response to receiving an indication, from, e.g., the feed, that event content associated with, e.g., events 206, 208, 210, 212, 214, 216, 218, and/or 220 and/or an index associated with, e.g., events 206, 208, 210, 212, 214, 216, 218, and/or 220 has changed or been updated, event process 10 may determine, score, rank, and/or provide updated result events based on such changes.

Further, in an embodiment, event process 10 may update the location of the client computing device based upon, at least in part, another received indication of the location of the client computing device. For example, assume for illustrative purposes that event process 10 determines that client electronic device 32 associated with user 40 is located in Manchester, N.H. Event process 10 may determine, score, rank, and/or provide one or more result events to user 40 based upon, at least in part, the Manchester, N.H. location. Further, assume for illustrative purposes that user 40 drives to Boston, Mass. Event process 10 may update the location of client electronic device 32 associated with user 40 if it receives another indication (e.g., location-based information or GPS information) from client electronic device 32 of the location of client electronic device 32 and determines the new location (e.g., Boston, Mass.).

Upon updating the location, event process 10 may again determine, score, rank, and/or provide one or more result events to user 40 based upon, at least in part, the Boston, Mass. location using one or more of the techniques or features described in the present disclosure. For example, event process 10 may update the scoring of the one or more result events (e.g., result events 216, 206, and 212) based upon, at least in part, the other received indication (e.g., location-based information or GPS information) of the location (e.g., Boston, Mass.) of the client computing device (e.g., client electronic device 32 associated with user 40). Further, event process 10 may update the ranking of the one or more result events (e.g., result events 216, 206, and 212) based upon, at least in part, the other received indication (e.g., location-based information or GPS information) of the location (e.g., Boston, Mass.) of the client computing device (e.g., client electronic device 32 associated with user 40).

It should be noted that where one or more of the techniques and features described herein are used to determine information about a user, the user may selectively decide whether to allow the feature to determine the information, or may selectively decide to prevent the feature from determining the information. For example, where one or more of the techniques and features described herein are used to determine information associated with the user's location, information associated with events that may interest the user, and information available from the user's social network, the user may selectively decide to allow the feature to determine the information, or may selectively decide to prevent the feature from determining the information.

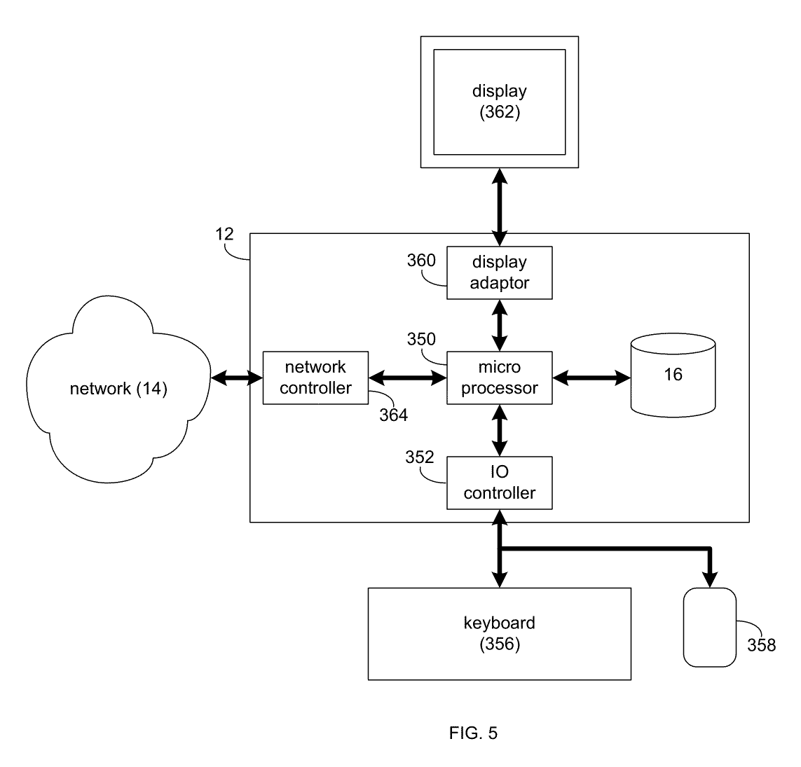

Referring also to FIG. 5, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, event process 10 may be substituted for computing device 12 within FIG. 5, examples of which may include but are not limited to client electronic devices 28, 30, 32, 34.

Computing system 12 may include microprocessor 350 configured to e.g., process data and execute instructions/code for event process 10. Microprocessor 350 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 352 may be configured to couple microprocessor 350 with various devices, such as keyboard 354, mouse 356, USB ports (not shown), and printer ports (not shown). Display adaptor 360 may be configured to couple display 362 (e.g., a CRT or LCD monitor) with microprocessor 350, while network adapter 364 (e.g., an Ethernet adapter) may be configured to couple microprocessor 350 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 350) of a general purpose computer/special purpose computer/other programmable data processing apparatus (e.g., computing device 12), such that the instructions, which execute via the processor (e.g., processor 350) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
in an event management application associated with a social networking application, receiving, at a computing device, a search request for an event to attend;
in response to receiving the search request, determining, at the computing device, one or more result events of one or more events to recommend to a user based upon, at least in part, one or more of information associated with the search, information associated with the user, information associated with the one or more events, and a location of a client computing device associated with a user, the location of the client computing device based upon, at least in part, a received indication of the location of the client computing device;
ranking, at the computing device, the one or more result events based upon, at least in part, one or more of the information associated with the search, the information associated with the user, the information associated with the one or more events, and the location, wherein the information associated with the user is based upon, at least in part, at least one of: a user interest, an online activity associated with the user, and media content associated with the user, and wherein the information associated with the one or more events is based upon, at least in part, at least one of: an event that the user previously attended, and an event associated with a connection of the user; and
providing, from, at least in part, the computing device, the ranked one or more result events.

2. A computer-implemented method comprising:
determining, at a computing device, one or more result events to recommend to attend based upon, at least in part, at least one of: an indication of a location of a client computing device associated with a user, and an index associated with the event, the index based upon, at least in part, event content associated with the event;
ranking, at the computing device, the one or more result events based upon, at least in part, at least one of: the index associated with the event and the indication of the location; and
providing, from, at least in part, the computing device, the ranked one or more result events.

3. The computer-implemented method of claim 2, further comprising:
updating the index associated with the event based upon, at least in part, receiving an indication that event content associated with the event has changed.

4. The computer-implemented method of claim 2, wherein determining the one or more result events is further based upon, at least in part, a user characteristic.

5. The computer-implemented method of claim 2, wherein the one or more result events are provided in response, at least in part, to receiving a search request.

6. The computer-implemented method of claim 2, wherein the one or more result events are provided as one or more suggestions without receiving a search request.

7. The computer-implemented method of claim 2, wherein the event content includes, at least in part, at least one of: event information including an invitee, an attendee, an event category, an event host, and an event organization.

8. The computer-implemented method of claim 2, wherein determining the one or more result events is further based upon, at least in part, at least one of: an event that a user previously attended, and an event associated with a connection of a user.

9. The computer-implemented method of claim 2, further comprising:
determining the location of the client computing device based upon, at least in part, the received indication of the location of the client computing device.

10. The computer-implemented method of claim 9, wherein determining the location of the client computing device is based upon, at least in part, one or more of an IP address associated with the client computing device, location-based information associated with the client computing device, and a location received via a search request.

11. The computer-implemented method of claim 2, wherein the one or more result events are ranked based upon, at least in part a nearness to the location of the client computing device.

12. The computer-implemented method of claim 11, further comprising:
updating the location of the client computing device based upon, at least in part, another received indication of the location of the client computing device.

13. The computer-implemented method of claim 12, further comprising:
updating the ranking of the one or more result events based upon, at least in part, the other received indication of the location of the client computing device.

14. A computing system comprising one or more processors, wherein the one or more processors are configured to:
determine one or more result events of one or more events to recommend to attend based upon, at least in part, one or more of information associated with a user and information associated with the one or more events;
determine a score for the one or more result events based upon, at least in part, one or more of the information associated with the user and the information associated with the one or more events;
determine a rank of the one or more result events based upon, at least in part, the score determined for the one or more result events; and
provide, from, at least in part, a computing device, the ranked one or more result events.

15. The computing system of claim 14, wherein the one or more processors are further configured to:
create an index associated with an event based upon, at least in part, information associated with the event; and
update the index associated with the event based upon, at least in part, receiving an indication that the information associated with event has changed.

16. The computing system of claim 14, wherein the one or more result events are provided in response, at least in part, to receiving a search request.

17. The computing system of claim 14, wherein the one or more result events are provided as one or more suggestions without receiving a search request.

18. The computing system of claim 14, wherein the information associated with the one or more events includes, at least in part, at least one of: event content, event information including an invitee, an attendee, an event category, an event host, and an event organization.

19. The computing system of claim 14, wherein the information associated with the user is based upon, at least in part, at least one of: a user characteristic, a user interest, an online activity associated with the user, media content associated with the user, and a location of a client computing device associated with the user.

20. The computing system of claim 19, wherein the one or more processors are further configured determine the location of the client computing device associated with the user based upon, at least in part, a received indication of the location of the client computing device.

21. The computing system of claim 20, wherein determining the location of the client computing device is based upon, at least in part, one or more of an IP address associated with the client computing device, a location-based information associated with the client computing device, and a location received via a search request.

22. The computing system of claim 19, wherein the one or more result events are scored based upon, at least in part, a nearness to the location of the client computing device.

23. The computing system of claim 20, wherein the one or more processors are further configured to:
update the location of the client computing device based upon, at least in part, another received indication of the location of the client computing device; and
update the scoring of the one or more result events based upon, at least in part, the other received indication of the location of the client computing device.

24. The computing system of claim 14, wherein determining the one or more result events is further based upon, at least in part, at least one of: an event that the user previously attended, and an event associated with a connection of the user, wherein the event associated with the connection of the user is based upon, at least in part, at least one of: an event that a connection of the user previously attended, an event for which a connection of the user indicated an intent to attend, an event hosted by a connection of the user, and an event associated with an organization that the user is connected to.

25. The computing system of claim 24, wherein the one or more processors are further configured to:
determine at least one of: the event that the user previously attended, and the event associated with the connection of the user based upon, at least in part, an index associated with an event.
